(19) United States
(12) Patent Application Publication
(10) Pub. No.: US 2021/0333399 A1
(43) Pub. Date: Oct. 28, 2021

(54) DETECTION METHOD, DETECTION DEVICE, AND LIDAR

(71) Applicant: SZ DJI TECHNOLOGY CO., LTD., Shenzhen (CN)

(72) Inventors: Jin ZHAO, Shenzhen (CN); Chenghui LONG, Shenzhen (CN); Huai HUANG, Shenzhen (CN)

(21) Appl. No.: 17/371,676

(22) Filed: Jul. 9, 2021

Related U.S. Application Data
(63) Continuation of application No. PCT/CN2019/071049, filed on Jan. 9, 2019.

(51) Int. Cl. G01S 17/87; G01S 7/48; G01D 5/347; G01B 5/24

(52) U.S. Cl. CPC G01S 17/87; G01B 5/24; G01D 5/34707; G01S 7/4808

(57) ABSTRACT

A detection method includes obtaining first count data and second count data during rotation of an encoder disc mounted at and configured to rotate together with a rotation object and determining a rotation parameter of the rotation object according to the first count data and the second count data. The encoder disc includes N detection target portions arranged along a circumferential direction of the encoder disc. The N detection target portions include N−K first detection target portions and K second detection target portions. Along the circumferential direction of the encoder disc, a width of one of the N−K first detection target portions is different from a width of one of the K second detection target portions. The first count data is obtained when one detection target portion of the N detection target portions is detected. The second count data is recorded between two neighboring detection target portions.

### CROSS-REFERENCE TO RELATED APPLICATION

This application is a continuation of International Application No. PCT/CN2019/071049, filed Jan. 9, 2019, the entire content of which is incorporated herein by reference.

### TECHNICAL FIELD

The present disclosure generally relates to the movement detection field and, more particularly to a detection method, a detection device, and a LIDAR.

### BACKGROUND

Currently, motors are broadly configured to drive objects to rotate. To obtain an angle when an object rotates, an encoder disc for detecting the angle is usually mounted at the object. To improve the detection accuracy of the rotation angle of the object, a tooth quantity of the encoder disc needs to be increased, and accuracy of a detection device also needs to be increased. For example, a laser device or a lens is applied to perform collimation. However, as such, cost and volume of a whole sensor may be increased.

### SUMMARY

Embodiments of the present disclosure provide a detection method. The method includes obtaining first count data and second count data during rotation of an encoder disc mounted at and configured to rotate together with a rotation object and determining a rotation parameter of the rotation object according to the first count data and the second count data. The rotation parameter includes a rotation angle and a rotation speed. The encoder disc includes N detection target portions arranged along a circumferential direction of the encoder disc. N is an integer greater than two. The N detection target portions include N−K first detection target portions and K second detection target portions. K is an integer greater than or equal to 1 and smaller than N. Along the circumferential direction of the encoder disc, a width of one of the N−K first detection target portions is different from a width of one of the K second detection target portions. The first count data is obtained when one detection target portion of the N detection target portions is detected. The second count data is recorded between two neighboring detection target portions of the N detection target portions.

Embodiments of the present disclosure provide a detection device including an encoder disc, a detection member, and a processor. The encoder disc is configured to be mounted at and rotate together with a rotation object. The encoder disc includes N detection target portions arranged along a circumferential direction of the encoder disc. N is an integer greater than 2. The N detection target portions include N−K first detection target portions and K second detection target portions. K is an integer greater than or equal to 1 and smaller than N. Along the circumferential direction of the encoder disc, a width of one of the N−K first detection target portions is different from a width of one of the K second detection target portions. The detection member is configured to detect the first detection target portions and the second detection target portions. The processor is configured to in rotation of the encoder disc obtain first count data when one detection target portion of the N detection target portions is detected and second count data between two neighboring detection target portions of the N detection target portions and determine a rotation parameter of the rotation object according to the first count data and the second count data. The rotation parameter includes a rotation angle and a rotation speed.

Embodiments of the present disclosure provide a LIDAR including an optical element, a driver, and a detection device. The driver is configured to driving the optical element to rotate. The detection device is configured to detect a rotation parameter of the optical element. The detection device includes an encoder disc, a detection member, and a processor. The encoder disc is configured to be mounted at and rotate together with a rotation object. The encoder disc includes N detection target portions arranged along a circumferential direction of the encoder disc. N is an integer greater than 2. The N detection target portions include N−K first detection target portions and K second detection target portions. K is an integer greater than or equal to 1 and smaller than N. Along the circumferential direction of the encoder disc, a width of one of the N−K first detection target portions is different from a width of one of the K second detection target portions. The detection member is configured to detect the first detection target portions and the second detection target portions. The processor is configured to in rotation of the encoder disc obtain first count data when one detection target portion of the N detection target portions is detected and second count data between two neighboring detection target portions of the N detection target portions and determine a rotation parameter of the rotation object according to the first count data and the second count data. The rotation parameter includes a rotation angle and a rotation speed.

### BRIEF DESCRIPTION OF THE DRAWINGS

FIG. 1 is a schematic structural diagram showing a portion of a detection device according to some embodiments of the present disclosure.

FIG. 2 is a schematic structural diagram showing another portion of the detection device according to some embodiments of the present disclosure.

FIG. 3 is a schematic planar structural diagram of an encoder disc according to some embodiments of the present disclosure.

FIG. 4 is a schematic diagram showing a waveshape of a detection signal when the encoder disc rotates clockwise according to some embodiments of the present disclosure.

FIG. 5 is a schematic diagram showing a waveshape of a detection signal when the encoder disc rotates counterclockwise according to some embodiments of the present disclosure.

FIG. 6 is a schematic flowchart of a detection method according to some embodiments of the present disclosure.

FIG. 7 is a schematic flowchart of another detection method according to some embodiments of the present disclosure.

FIG. 8 is a schematic flowchart of another detection method according to some embodiments of the present disclosure.

FIG. 9 is a schematic flowchart of another detection method according to some embodiments of the present disclosure.

FIG. 10 is a schematic flowchart of another detection method according to some embodiments of the present disclosure.

FIG. 11 is a schematic flowchart of another detection method according to some embodiments of the present disclosure.

FIG. 12 is a schematic flowchart of another detection method according to some embodiments of the present disclosure.

FIG. 13 is a schematic block diagram of a LIDAR according to some embodiments of the present disclosure.

FIG. 14 is a schematic structural diagram of a LIDAR according to some embodiments of the present disclosure.

Reference numerals:

| 10 | Detection device; | 12 | Encoder disc; | 120 | Detection area; |
|---|---|---|---|---|---|
| 122 | Detection target portion; | | | 1222 | First detection target |
| 1224 | Second detection target portion; | | | | portion; |
| 124 | Encoder disc portion; | | | 1242 | First encoder disc portion; |
| 1244 | Second encoder disc portion; | | | 126 | Snap slot; |
| 14 | Detection member; | 100 | LIDAR; | 20 | Ranging device; |
| 201 | Emission circuit; | 203 | Reception circuit; | 205 | Sampling circuit; |
| 207 | Computation circuit; | 209 | Control circuit; | 22 | Emitter; |
| 24 | Collimation element; | 26 | Detector; | 28 | Optical path change element; |
| 30 | Scan device; | 31 | Lens barrel; | 312 | Snap piece; |
| 32 | Optical element; | 322 | First optical element; | 324 | Second optical element; |
| 34 | Driver; | 342 | First Driver; | 344 | Second Driver; |
| 36 | Rotation shaft; | 40 | Controller; | 50 | Collimated beam. |

### DETAILED DESCRIPTION OF THE EMBODIMENTS

Embodiments of the present disclosure are described in detail below. Embodiments of the present disclosure are shown in the accompanying drawings. Same or similar signs represent same or similar elements or elements with same or similar functions. Embodiments of the present disclosure described with reference to the accompanying drawings are exemplary and merely used to explain the present disclosure, which can not be understood as a limitation of the present disclosure.

In the specification of the present disclosure, terms of “first” and “second” are merely used for descriptive purposes and should not be understood as indicating or implying relative importance or implicitly indicating a number of the indicated technical features. Therefore, a feature associated with “first” or “second” may explicitly or implicitly include one or more of such features. In the specification of the present disclosure, “a plurality of” means two or more than two, unless otherwise specified.

In the specification of the present disclosure, unless otherwise specified, the terms “mounting,” “connection,” and “coupling” should be interpreted broadly, for example, they may include a fixed connection, a detachable connection, or an integral connection. The connection may further include a mechanical connection, electrical communication, or mutual communication. The connection may further include a connection through an intermediate medium, a communication inside two elements, or an interaction relationship of the two elements. Those of ordinary skill in the art may understand specific meanings of the terms in the present disclosure.

In the following description, many details are provided to better understand the present disclosure. To simplify the present disclosure, components and settings of specific examples are described. These examples are merely exemplary and do not limit the present disclosure. In addition, reference numerals or reference letters can be repeated in different examples of the present disclosure. Such repetition is for the purpose of simplicity and clarity and does not indicate the relationship between embodiments and/or settings that are discussed. In addition, the present disclosure provides examples of various specific processes and materials. However, those of ordinary skill in the art can still think of application of another process and/or application of another material.

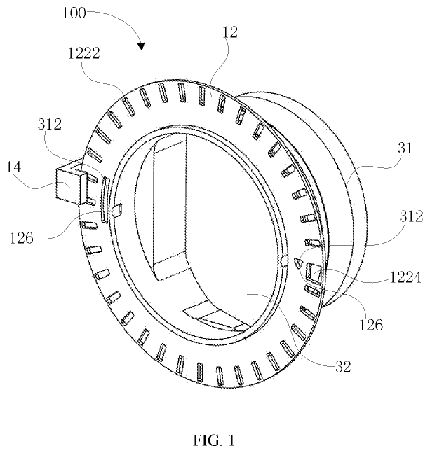

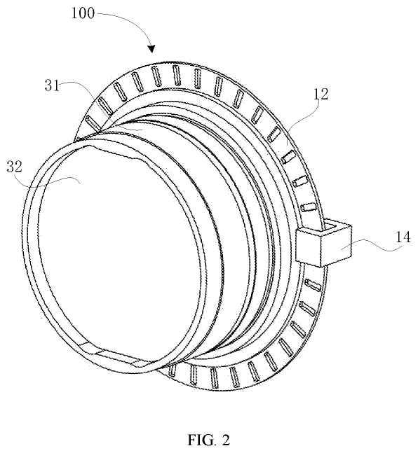

A detection method of embodiments of the present disclosure may be used to detect a rotation parameter of a rotation object and may be implemented by a detection device 10 of embodiments of the present disclosure. That is, the rotation parameter of the rotation object during rotation may be detected by the detection device 10. With reference to FIG. 1 and FIG. 2, the detection device 10 includes an encoder disc 12, a detection member 14, and a processor (not shown). The processor may be connected to the detection member 14. The rotation object is mounted with the encoder disc 12. The encoder disc 12 may rotate with the rotation of the rotation object. In some embodiments, the rotation object and the encoder disc 12 may be relatively still. Therefore, the encoder disc 12 may be configured to detect the rotation parameter of the rotation object. The rotation parameter may include at least one of a rotation direction, a rotation angle, or a rotation speed.

As shown in FIG. 1 and FIG. 2, the rotation object includes an optical element 32. The optical element 32 is arranged in a lens barrel 31. The lens barrel 31 includes a snap piece 312. The encoder disc 12 includes a snap slot 126. The snap piece 312 is at least partially snapped in the snap slot 126 to mount the encoder disc 12 at the lens barrel 31. As such, a relative position between the encoder disc 12 and the optical element 32 may not change. During the rotation, the encoder disc 12 and the optical element 32 may keep relatively still. The encoder disc 12 and the optical element 32 may rotate synchronically. Thus, the rotation parameter of the optical element 32 may be detected through the encoder disc 12.

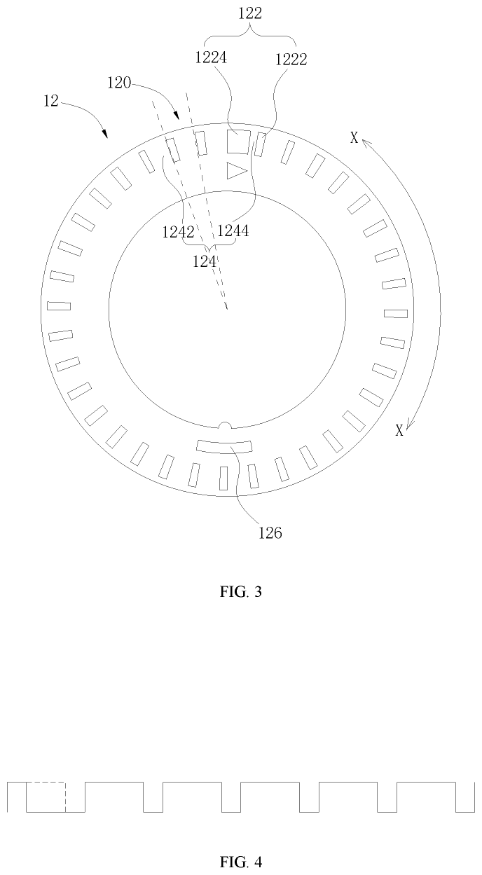

With reference to FIG. 3, in the present disclosure, along a circumferential direction X of the encoder disc 12, the encoder disc 12 is divided into N detection areas 120 with an equal width. Each detection area 120 includes a detection target portion 122 and an encoder disc portion 124. The detection target portions 122 and the encoder disc portions 124 are arranged alternately. That is, along the circumferential direction X of the encoder disc 12, N detection target portions 122 and N encoder disc portions 124 are arranged at the encoder disc 12. The N detection target portions 122 include N−K first detection target portions 1222 with an equal width and K second detection target portions 1224 with an equal width. The N encoder disc portions 124 include N−K first encoder disc portions 1242 with an equal width and K second encoder disc portions 1244 with an equal width. N may be an integer greater than 2. K may be an integer and 1≤K<N. Along the circumferential direction X of the encoder disc 12, the width of the first detection target portion 1222 is different from the width of the second detection target portion 1224. As shown in FIG. 3, the encoder disc is in a circular shape.

Along the circumferential direction X of the encoder disc 12, each detection area 120 includes the equal width. A certain detection area 120 or each of some detection areas 120 may include a first detection target portion 1222 and a first encoder disc portion 1242. A certain detection area 120 or each of some detection areas 120 may include a second detection target portion 1224 and a second encoder disc portion 1244. For the detection area 120, a sum of the width of the first detection target portion 1222 and the width of the first encoder disc portion 1242 may be equal to a sum of the width of the second detection target portion 1224 and the width of the second encoder disc portion 1244.

In some embodiments, as shown in the drawing, along the circumferential direction X of the encoder disc 12, the width of the first detection target portion 1222 is smaller than the width of the second detection target portion 1224. The width of the first encoder disc portion 1242 is greater than the width of the second encoder disc portion 1244. In some embodiments, along the circumferential direction X of the encoder disc 12, the width of the first detection target portion 1222 may be equal to the width of the second encoder disc portion 1244. The width of the second detection target portion 1224 may be equal to the width of the first encoder disc portion 1242. The width f the second detection target portion 1224 may be three times the width of the first detection target portion 1222. That is, the width of the second detection target portion 1224: the width of the first detection target portion 1222 is equal to 3:1. A multiple-time relationship between the width of the second detection target portion 1224 and the width of the first detection target portion 1222 may include 2 or another number and may not be limited to 3.

In some embodiments, the width may refer to a circumferential width (angle) along the circumferential direction X of the encoder disc 12. A number of the detection areas 120 may be determined according to a dimension of the encoder disc 12, detection accuracy, and a data processing amount of the processor. The number N of the detection areas 120 may be a number that can equally divide 360°, e.g., N may be 18, 36, 72, etc. In some embodiments, considering that the dimension of the encoder disc 12 should not be too large, does not increase the burden on the processor, and can meet accuracy requirements, the number N of the detection areas 120 arranged at the encoder disc 12 may be 36. That is, the width of each detection area 120 may be equal to 10°. The number of the first detection target portions 1222 and the number of the second detection target portions 1224 may be set as needed. In some embodiments, the number of the second detection target portion 1224 may be set to 1, that is, K=1, and the number of the first detection target portions 1222 may be equal to 35. The width may be represented by another unit, e.g., millimeter.

To facilitate understanding, an example that the encoder disc 12 may include 35 first detection target portions 1222, 1 second detection target portion 1224, 35 first encoder disc portion 1242, and 1 second encoder disc portion 1244 may be taken for the description below. Along the circumferential direction X of the encoder disc 12, the width of the first detection target portion 1222 may be equal to the width of the second encoder disc portion 1244. The width of the second detection target portion 1224 may be equal to the width of the first encoder disc portion 1242. The width of the second detection target portion 1224 may be three times the width of the first detection target portion 1222.

In the present disclosure, the detection member 14 may be arranged at the circumference of the encoder disc 12 and may be configured to detect the first detection target portion 1222 and the second detection target portion 1244. Since the width of the first detection target portion 1222 and the width of the second detection target portion 1224 are different, when the encoder disc 12 rotates for a round, detection signals detected by the detection member 14 may be different. Therefore, in the present disclosure, the rotation parameter of the rotation object may be obtained through the detection signals output by the detection member 14.

In some embodiments, the detection target portion 122 may include a through-hole, a magnetic member, a light transmission member, or a light reflection member. When the detection target portion 122 includes the through-hole, the light transmission member, or the light reflection member, correspondingly, the detection member 14 may include a photoelectrical switch. When the detection target portion 122 includes the light reflection member, the reflectivity of the light reflection member may be greater than the reflectivity of the encoder disc portion 124. When the detection target portion 122 includes the magnetic member, correspondingly, the detection member 14 may include a Hall element. In some embodiments, the detection target portion 122 may include the through-hole, and the detection member may include the photoelectrical switch. The detection target portion 122 may transmit light, and the encoder disc portion 124 cannot transmit light.

The photoelectrical switch may include a slot-type photoelectrical switch (i.e., through-beam photoelectrical switch), which may include a base (not shown), an emission diode (not shown), and a reception diode (not shown). The emission diode and the reception diode may be arranged at the base at an interval. The emission diode and the reception diode may be symmetrically arranged at two sides of the encoder disc 12. Centers of the emission diode and the reception diode may be located at the circumference where the detection target portion 122 and the encoder disc portion 124 are to match with the detection target portion 122 and the encoder disc portion 124. The base may be arranged at a position having a predetermined interval to an outer circumference of the encoder disc 12 to prevent collision between the outer circumference of the encoder disc 12 and the base during the rotation of the encoder disc 12. The photoelectrical switch may include a reflective-type photoelectrical switch.

During the rotation of the encoder disc 12 driven by the rotation object, the photoelectrical switch may be still. The emission diode of the photoelectrical switch may emit a light signal. When the detection target portion 122 rotates to a position between the emission diode and the reception diode, and the detection target portion 122 includes the through-hole or the light transmission member, the reception diode may receive the light signal emitted by the emission diode. When the encoder disc portion 124 rotates to the position between the emission diode and the reception diode, the reception diode cannot receive the light signal emitted by the emission diode. Thus, when the detection target portion 122 and the encoder disc portion 124 of the encoder disc 12 rotate to the position of the photoelectrical switch, the photoelectrical switch may output different level signals (e.g., voltage signals, current signals, etc.).

In some embodiments, when the detection target portion 122 rotates to the position of the detection member 14 (photoelectrical switch), a detection signal output by the detection member 14 may include a first signal. When the encoder disc portion 124 rotates to the position of the detection member 14 (photoelectrical switch), the detection signal output by the detection member 14 may include a second signal. The first signal may be different from the second signal. Since the detection target portions 122 and the encoder disc portions 124 are arranged alternately, the detection signal may alternately include the first signal and the second signal. In some embodiments, along the circumferential direction X of the encoder disc 12, the width of the first detection target portion 1222 may be smaller than the width of the second detection target portion 1224. Therefore, a length of the first signal corresponding to the first detection target portion 1222 may be longer than a length of the first signal corresponding to the second detection target portion 1224.

The first signal may include a low-level signal (e.g., voltage signals, current signals, etc.), and the second signal may include a high-level signal (e.g., voltage signals, current signals, etc.). For example, the low-level signal may include a signal with a level of 0, and the high-level signal may include a signal with a level of 1. The detection signal may include a sine wave signal, a cosine wave signal, or a triangle wave signal. In some embodiments, the detection signal may include a square wave signal.

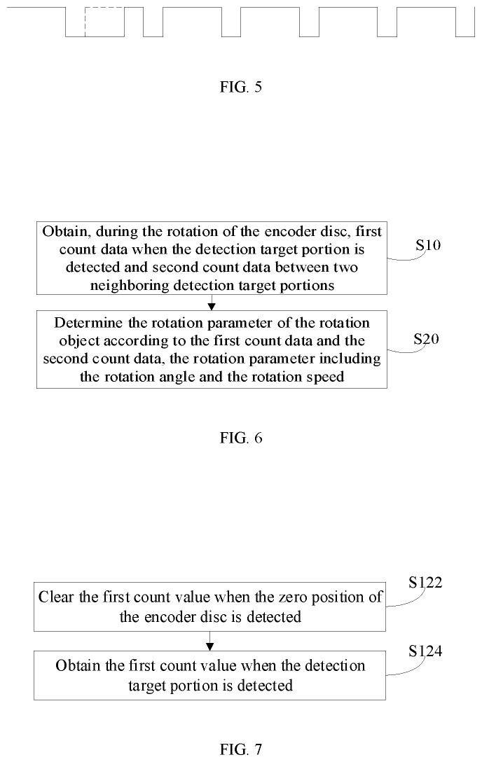

With reference to FIG. 4 and FIG. 5, the rotation object rotates to drive the encoder disc 12 to rotate. The encoder disc 12 rotates for one round, that is, in a rotation cycle, the detection member 14 may detect consecutive first signal and second signal (i.e., one of the first and second signals is immediately after another one of the first and second signals) having a same length. When the encoder disc 12 rotates clockwise, between the consecutive first signal and second signal having the same length, the first signal may be detected first. When the encoder disc 12 rotates counterclockwise, between the consecutive first signal and second signal having the same length, the second signal may be detected first. As such, based on the detection signal of FIG. 4 or FIG. 5, the rotation direction of the rotation object may be detected from the wave shape within one rotation cycle.

With reference to FIG. 6, the detection method includes obtaining, during the rotation of the encoder disc 12, first count data when the detection target portion 122 is detected and second count data between two neighboring detection target portions 122 (S10), and determining the rotation parameter of the rotation object according to the first count data and the second count data, the rotation parameter including the rotation angle and the rotation speed (S20).

The detection method of embodiments of the present disclosure, the rotation parameter may be determined through the two count data. As such, the volume and cost of the detection device 10, which is configured to detect the rotation parameter of the rotation object, may be reduced. The detection precision of the rotation parameter of the rotation object may be ensured.

The detection device 10 may include a first counter (not shown) and a second counter (not shown). The first count data may be recorded by the first counter, and the second count data may be recorded by the second counter. The first count data may include a first count value and a first count frequency. The second count data may include a second count value and a second count frequency. The first counter and the second counter may include a counter in a field-programmable gate array (FPAG) or another counter.

In some embodiments, with reference to FIG. 7, obtaining the first count data when the detection target portion 122 is detected includes clearing the first count value when the zero position of the encoder disc 12 is detected (S122) and obtaining the first count value when the detection target portion 122 is detected (S124).

In some embodiments, the zero position of the encoder disc 12 may correspond to a position of one of the second detection target portions 1224. Therefore, the zero position of the encoder disc 12 may be determined according to the detected waveshape. For example, as shown in FIG. 3, the encoder disc 12 includes the 35 first detection target portions 1222 and the one second detection target portions 1224. Since the width of the second detection target portion 1224 is greater than the width of the first detection target portions 1222, the detection signal may include a longer first signal (low-level signal). A zero position (e.g., a specific area of the second detection target portion 1224, such as a middle axis, left and right edges, etc.) may be encountered each time the encoder disc 12 rotates for one round. In some embodiments, the left edge of the second detection target portion 1224 may be used as the zero position of the encoder disc 12. When the encoder disc 12 rotates counterclockwise, and a descending edge of the first signal that is longer is detected, that is, the zero position of the encoder disc 12 is detected, the first count value may be cleared. Then, the first counter may start to count from zero continuously at a same frequency. When the encoder disc 12 rotates for one round, the first count value may be cleared once. The first count value corresponding to the zero position may be C₁, that is C₁=0. When a next detection target portion 122 is detected, the first count value C₂ corresponding the next detection target portion 122 may be recorded. As such, the first count values C1, C2, C3, . . . , C36 corresponding to each of the detection target portions 122 and a value C_{A} of the first count value before being cleared may be recorded separately, and C₁<C₂<C₃< . . . <C₃₆<C_{A}. The first count value corresponding to each detection target portion 122 may include the value recorded at the descending edge of the first signal. In some embodiments, C₁ may be the first count value when a left edge of the second detection target portion 1224 is detected. C₂ to C₃₆ may be the first count values when the left edges of the 35 first detection target portions 1222 are detected.

Further, the lengths of the first signal and the second signal detected by the detection member 14 are related to the rotation speed of the encoder disc 12. The rotation speed of the encoder disc 12 may be determined by the rotation speed of the rotation object. When the rotation object rotates at an even speed, the zero position of the encoder disc 12 may be detected by one detection member 14. When the rotation object rotates at a variable speed, the lengths of the first signal and the second signal detected by the detection member 14 may be uncertain. Since the first counter counts continuously at the same frequency, the width of the detection target portion 122 corresponding to each first signal or the width of the encoder disc portion 124 corresponding to each second signal may be determined in connection with the first count value to determine the zero position of the encoder disc 12. The relationship between the zero position of the encoder disc 12 and the zero position of the rotation object may be predetermined. In some embodiments, the zero position of the encoder disc 12 may be set as the zero position of the rotation object.

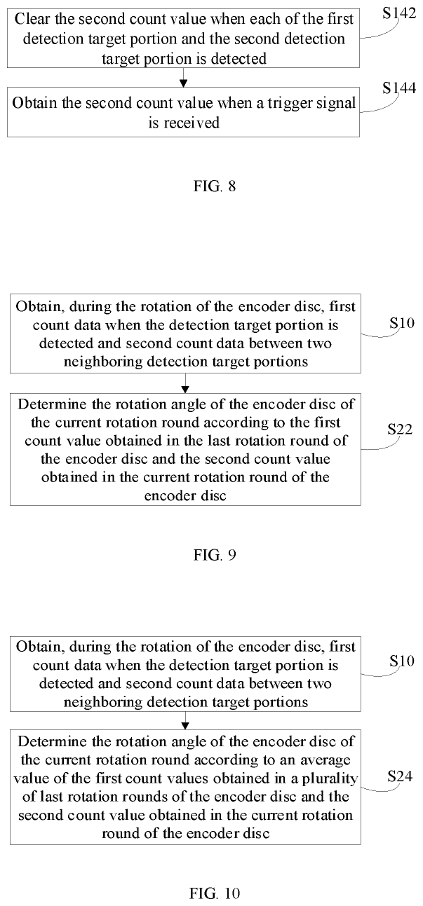

With reference to FIG. 8, obtaining the second count data between the two neighboring detection target portions 122 includes clearing the second count value when each of the first detection target portion 1222 and the second detection target portion 1224 is detected (S142) and obtaining the second count value when a trigger signal is received.

Each time when the first detection target portion 1222 and the second detection target portion 1224 are detected, the second count value may be cleared. The second counter may count continuously from 0 at the same frequency. When the trigger signal is received, the second count value C_{C} may be recorded. The trigger signal may include a signal triggered when the rotation object emits light and/or receives light. If the trigger signal includes the signal triggered when the rotation object emits light, the rotation angle of the rotation object may be determined in connection with the second count value and the first count value when the rotation object emits the light. If the trigger signal includes the signal triggered when the rotation object receives light, the rotation angle of the rotation object may be determined in connection with the second count value and the first count value when the rotation object receives the light.

With reference to FIG. 9, process S20 includes determining the rotation angle of the encoder disc 12 of the current rotation round according to the first count value obtained in the last rotation round of the encoder disc 12 and the second count value obtained in the current rotation round of the encoder disc 12 (S22).

With reference to FIG. 10, process S20 includes determining the rotation angle of the encoder disc 12 of the current rotation round according to an average value of the first count values obtained in a plurality of last rotation rounds of the encoder disc 12 and the second count value obtained in the current rotation round of the encoder disc 12 (S24).

The rotation angle of the encoder disc 12 of the current rotation round may include the rotation angle of the rotation object of the current rotation round.

In some embodiments, process S22 includes upon reception of the trigger signal, determining the rotation angle of the encoder disc 12 of the current rotation round by using the first count value obtained in the last rotation round of the encoder disc 12, the second count value obtained in the current rotation round of the encoder disc 12, and an accumulation value of the first count value obtained in the last rotation round of the encoder disc 12, of a last detection target portion 122 in a rotation direction of the encoder disc 12. In this disclosure, a last detection target portion 122 in the rotation direction of the encoder disc 12 refers to the last detection target portion 122 that passed by the detection member 14 right before the trigger signal is received. Process S24 includes upon reception of the trigger signal, determining the rotation angle of the encoder disc 12 of the current rotation round by using the average value of the first count values obtained in the plurality of last rotation rounds of the encoder disc 12, the second count value obtained in the current rotation round of the encoder disc 12, and the average value of the accumulation values of the first count value obtained in the plurality of last rotation rounds of the encoder disc 12, of the last detection target portion 122 in the rotation direction of the encoder disc 12.

Since the mechanical processing of the encoder disc 12 includes a certain error, the widths of the N−K first detection target portions may be different, and the widths of the K (K>1) second detection target portions may be different. In addition, in the rotation of the encoder disc 12, an actual rotation speed may include an error from the detected rotation speed. As such, the accuracy of the rotation angle in the current rotation round of the encoder disc 12 may be affected. In process S22, the rotation angle in the current rotation round of the encoder disc 12 may be determined by using the first count value of the detection target portion 122 obtained in the last rotation round of the encoder disc 12 as a basis to continuously correct the error generated by the rotation of the encoder disc 12 to obtain more accurate rotation angle in the current rotation round of the encoder disc 12. In process S24, the rotation angle in the current rotation round of the encoder disc 12 may be determined by using the average value of the first count values of the detection target portion 122 obtained in the last rotation rounds of the encoder disc 12 as a basis to correct the error generated by the rotation of the encoder disc 12 to obtain the more accurate rotation angle in the current rotation round of the encoder disc 12. In the present disclosure, the accumulation value of the first count value may be the value C_{A} before the first count value is cleared. The last rotation rounds may include the last two or more rounds before the current round.

In some embodiments, in connection with FIG. 3, the second detection target portion 1224 is set to be a first one of the detection target portions 122. The first one of the detection target portions 122 corresponds to the zero position of the encoder disc 12. If the encoder disc 12 rotates counterclockwise, a first one of the first detection target portions 1222 includes a second one of the detection target portions 122, and the second one of the first detection target portions 1222 includes a third one of the detection target portions 122, and so on. When the encoder disc 12 rotates counterclockwise, and the trigger signal is received, a portion between the second one of the detection target portions 122 and the third one of the third detection target portions 122 may rotate to the detection member 14, and the second count value C_{C} may be obtained. The first count value C2 of the second one of the detection target portions 122 (i.e., upon reception of the trigger signal, the last detection target portion 122 along the counterclockwise rotation direction of the encoder disc 12) may be detected in the last rotation round of the encoder disc 12. An accumulation value of the first count value obtained in the last rotation round of the encoder disc 12 may be C_{A}. The rotation angle in the current rotation round of the encoder disc 12 may be equal to (C_{2(N-1)}+C_{C(N)})/C_{A(N-1)}*360°. Subscript (N−1) denotes an (N−1)-th round, that is the last round. Subscript N denotes an N-th round, that is the current round. In some embodiments, the detection precision of the rotation angle of the encoder disc may reach 0.01°.

The rotation angle in the current rotation round of the encoder disc 12 may refer to an angle difference between the zero position of the encoder disc 12 during rotation and the zero position of the encoder disc 12 before rotation.

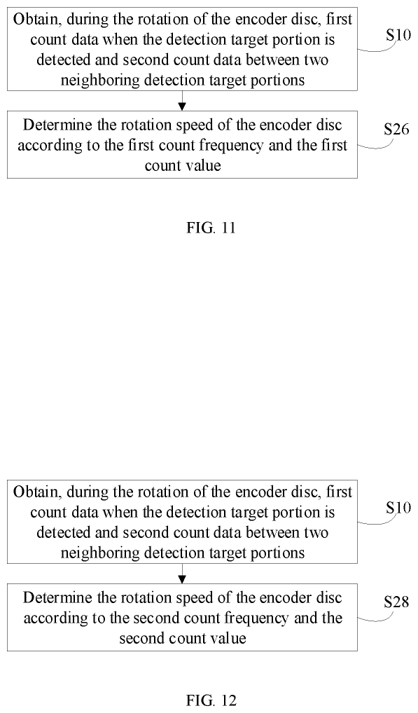

With reference to FIG. 11, process S20 includes determining the rotation speed of the encoder disc 12 according to the first count frequency and the first count value (S26).

With reference to FIG. 12, process S20 includes determining the rotation speed of the encoder disc 12 according to the second count frequency and the second count value (S28).

The rotation speed of the encoder disc 12 may include the rotation speed of the rotation object.

In some embodiments, process S26 includes determining a time length needed for the encoder disc 12 to rotate for one round according to the first count frequency and the first count value to determine the rotation speed of the encoder disc 12. Process S28 includes determining a time length needed for the encoder disc 12 to rotate for one round according to the second count frequency and the second count value to determine the rotation speed of the encoder disc 12.

When the encoder disc 12 rotates at an even speed, the time length needed for the encoder disc 12 to rotate for one round may be determined according to the first count data and the second count data to determine the rotation speed of the encoder disc 12. A time length needed for the encoder disc 12 to rotate for the width of the detection target portion 122 or the width of the encoder disc portion 124 may be determined according to the first count data and the second count data to determine the rotation speed of the encoder disc 12.

With reference to FIG. 1 and FIG. 2, the detection device 10 of embodiments of the present disclosure is configured to detect the rotation parameter of the rotation object. The detection device 10 includes the encoder disc 12, the detection member 14, and the processor. The encoder disc 12 may be configured to be mounted at the rotation object. The encoder disc 12 may rotate as the rotation object rotates. The N detection target portions 122 may be arranged along the circumferential direction X of the encoder disc 12, and N may be an integer greater than 2. The N detection target portions 122 include the N−K first detection target portions 1222 and the number K second detection target portions 1224. K may be an integer and 1≤K<N. Along the circumferential direction X of the encoder disc 12, the width of the first detection target portion 1222 is different from the width of the second detection target portion 1224. The processor may be configured to during the rotation of the encoder disc 12, obtaining the first count data when the detection target portion 122 is detected and the second count data between the two neighboring detection target portions 122 and determine the rotation parameter of the rotation object according to the first count data and the second count data. The rotation parameter may include the rotation angle and the rotation speed.

That is, process S10 and process S20 of the above detection method may be implemented by the processor.

The detection device 10 of embodiments of the present disclosure may be configured to determine the rotation parameter of the rotation object according to the two count data. As such, the volume and cost of the detection device 10, which is configured to detect the rotation parameter of the rotation object, may be reduced. The detection precision of the rotation parameter of the rotation object may be ensured.

The description and beneficial effects of the detection method of embodiments of the present disclosure may be suitable for the detection device 10 of embodiments of the present disclosure, which is not detailed here to avoid redundancy.

In some embodiments, the first count data may include the first count value. The processor may be configured to clear the first count value when detecting the zero position of the encoder disc 12 and obtain the first count value when detecting the detection target portion 122.

That is, process S122 and process S124 of the above detection method may be implemented by the processor.

In some embodiments, the zero position of the encoder disc 12 may correspond to the position of a certain second detection target portion 1224.

In some embodiments, the second count data may include the second count value. The processor may be configured to clear the second count value when detecting each of the first detection target portion 1222 and the second detection target portion 1224 and obtain the second count value when receiving the trigger signal.

That is, process S142 and process S144 of the above detection method may be implemented by the processor.

In some embodiments, the trigger signal may include the signal triggered when the rotation object emits light and/or receives light.

In some embodiments, the first count data may include the first count value, and the second count data may include the second count value. The processor may be configured to determine the rotation angle in the current rotation round of the encoder disc 12 by using the first count value obtained in a last rotation round of the encoder disc 12 and the second count value obtained in the current rotation round of the encoder disc 12 or using the average value of the first count values obtained in the last rotation rounds of the encoder disc 12 and the second count value obtained in the current rotation round of the encoder disc 12.

That is, process S22 and process S24 of the above detection method may be implemented by the processor.

In some embodiments, the processor may be configured to in reception of the trigger signal, determine the rotation angle of the encoder disc 12 of the current rotation round by using the first count value obtained in the last rotation round of the encoder disc 12, the second count value obtained in the current rotation round of the encoder disc 12, and the accumulative value of the first count value obtained in the last rotation round of the encoder disc 12, of the last detection target portion 122 in the rotation direction of the encoder disc 12 or using the average value of the first count values obtained in the last rotation rounds of the encoder disc 12, and the second count value obtained in the current rotation round of the encoder disc 12, and the average value of the accumulation values of the first count value obtained in the plurality of last rotation rounds of the encoder disc 12, of the last detection target portion 122 in the rotation direction of the encoder disc 12.

In some embodiments, the first count data may include the first count value and the first count frequency, and the second count data may include the second count value and the second count frequency. The processor may be configured to determine the rotation speed of the encoder disc 12 according to the first count value and the first count frequency or the second count value and the second count frequency. The rotation speed of the encoder disc 12 may include the rotation speed of the rotation object.

That is, process S26 and process S28 of the above detection method may be implemented by the processor.

In some embodiments, the processor may be configured to determine the time length needed for the encoder disc 12 to rotate for one round according to the first count frequency and the first count value to determine the rotation speed of the encoder disc 12 or determine a time length needed for the encoder disc 12 to rotate for one round according to the second count frequency and the second count value to determine the rotation speed of the encoder disc 12.

In some embodiments, along the circumferential direction X of the encoder disc 12, the encoder disc 12 may be divided into the N detection areas 120 with an equal width. Each detection area 120 may include the detection target portion 122 and the encoder disc portion 124. The detection target portions 122 and the encoder disc portions 124 may be arranged alternately.

In some embodiments, the N encoder disc portions 124 may include the N−K first encoder disc portions 1242 and K second encoder disc portions 1244. Along the circumferential direction X of the encoder disc 12, the width of the first detection target portion 1222 is smaller than the width of the second detection target portion 1224. The width of the first encoder disc portion 1242 may be greater than the width of the second encoder disc portion 1244.

In some embodiments, along the circumferential direction X of the encoder disc 12, the width of the first detection target portion 1222 is equal to the width of the second encoder disc portion 1244. The width of the second detection target portion 1224 may be equal to the width of the first encoder disc portion 1242. The width of the second detection target portion 1224 may be three times the width of the first detection target portion 1222.

In some embodiments, the detection target portion 122 may include a through-hole, a magnetic member, a light transmission member, or a light reflection member.

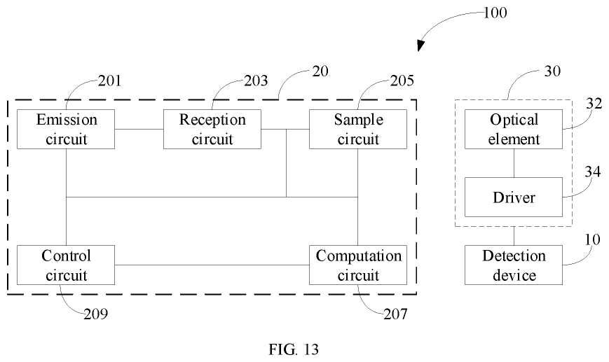

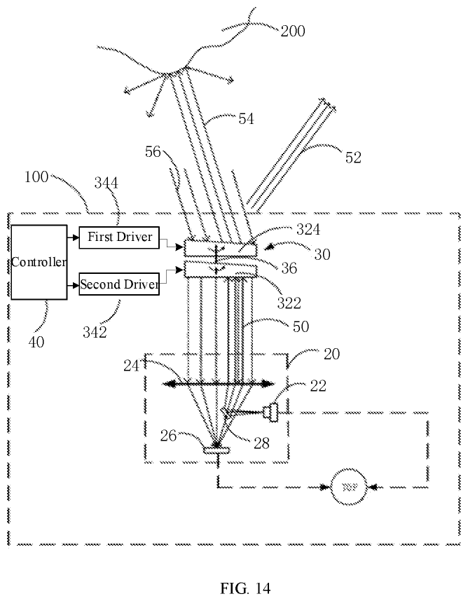

With reference to FIG. 13 and FIG. 14, a LIDAR 100 of embodiments of the present disclosure includes an optical element 32, a driver 34 for driving the optical element 32 to rotate, and the above detection device 10. The detection device 10 may be configured to detect a rotation parameter of the optical element 32.

The LIDAR 100 of embodiments of the present disclosure may determine the rotation parameter of the optical element 32 according to the two count data. As such, the volume and cost of the detection device 10, which is configured to detect the rotation parameter of the optical element 32, may be reduced. The detection precision of the rotation parameter of the optical element 32 may be ensured.

The optical element 32 may be the above rotation object. The driver 34 may include a motor. A rotor of the motor may be connected to the optical element 32 to drive the optical element 32 to rotate. The rotor of the motor may rotate synchronically with the optical element 32. That is, the rotor of the motor and the optical element 32 may remain relatively still. The optical element 32 may include a prism or a lens. The prism may include a wedge-shaped prism.

In some embodiments, the lens may have different thicknesses along a radial direction. The second detection target portion 1224 of the encoder disc 12 may be only aligned to a position of the lens, which has a minimal or maximal thickness along the radial direction.

The position of the lens having the minimal thickness or the maximal thickness may be used as the zero position of the lens. The zero position of the lens may be identified by using the zero position of the encoder disc 12. As such, the position of the lens having the minimal thickness or the maximal thickness may be identified indirectly to cause the lens to form a determined optical path. In some embodiments, the zero position of the lens may be aligned to the zero position of the encoder disc 12.

The LIDAR 100 of embodiments of the present disclosure may be configured to measure a distance. In some embodiments, the LIDAR 100 may be configured to sense external environment information, for example, distance information of an environment target, orientation information, reflection intensity information, speed information, etc. In some embodiments, the LIDAR 100 may be configured to detect a distance from a detected object 200 to the LIDAR 100 by measuring light transmission time, i.e., time-of-flight (TOF), between the LIDAR 100 and the detected object 200. In some other embodiments, the LIDAR 100 may be configured to detect the distance from the detected object 200 to the LIDAR 100 through another technology, for example, a ranging method based on phase shift measurement or frequency shift measurement, which is not limited here.

To facilitate understanding, an operation process of ranging will be described as an example in conjunction with the LIDAR 100 shown in FIG. 13.

As shown in FIG. 13, the LIDAR 100 includes a ranging device 20 and a scan device 30. The ranging device 20 includes an emission circuit 201, a reception circuit 203, a sampling circuit 205, and a computation circuit 207.

The emission circuit 201 may be configured to emit a light pulse sequence (e.g., a laser pulse sequence). The reception circuit 203 may be configured to receive the light pulse sequence reflected by the detected object, perform photoelectric conversion on the light pulse sequence to obtain an electrical signal, and output the processed electrical signal to the sampling circuit 205. The sampling circuit 205 may be configured to perform sampling on the electrical signal to obtain a sampling result. The computation circuit 207 may be configured to determine the distance between the LIDAR 100 and the detected object 200 based on the sampling result of the sampling circuit 205.

In some embodiments, the ranging device 20 further includes a control circuit 209. The control circuit 209 may be configured to control another module or circuit. For example, the control circuit 209 may be configured to control the operation time of the modules and circuits and/or perform parameter setting on the modules and the circuits.

Although the ranging device 20 shown in FIG. 13 includes the emission circuit 201, the reception circuit 203, the sampling circuit 205, and the computation circuit 207 and is configured to emit a beam for detection. However, the present disclosure is not limited to this. A quantity of any one device of the emission circuit 201, the reception circuit 203, the sampling circuit 205, and the computation circuit 207 may be at least two. The ranging device 20 may be configured to emit at least two beams along a same direction or different directions. The at least two beams may be emitted simultaneously or at different times. In some embodiments, light-emitting chips of the at least two emission circuits 201 may be packaged in a same module. For example, each emission circuit 201 may include a laser emission chip. The dies of the laser emission chips of the at least two emission circuits may be packaged together and accommodated in a same package space.

The scan device 30 may include the optical element 32 and the driver 34 for driving the optical element 32 to rotate. The scan device 30 may be configured to change the transmission direction of at least one beam of the laser pulse sequence emitted by the emission circuit 201 and emit the at least one laser pulse sequence.

A co-axial optical path may be used in the LIDAR 100. That is, the beam emitted from the LIDAR 100 and a beam reflected may share at least a part of the optical path in the LIDAR 100. For example, the at least one beam of the light pulse sequence emitted by the emission circuit 201 may be emitted after the transmission direction of the at least one beam of the light pulse sequence is changed by the scan device 30. The laser pulse sequence reflected by the detected object 200 may enter into the reception circuit 203 through the scan device 30. In some other embodiments, off-axial optical paths may be used in the LIDAR 100. That is, the beam emitted by the LIDAR 100 and the beam reflected may be transmitted along different paths in the LIDAR 100. FIG. 14 is a schematic diagram of a LIDAR 100 using a co-axial optical path according to some embodiments of the present disclosure.

The LIDAR 100 includes a ranging device 20 and a scan device 30. The ranging device 20 includes an emitter 22 (including the emission circuit 201), a collimation element 24, a detector 26 (including the reception circuit 203, the sampling circuit 205, and the computation circuit 207), and an optical path change element 28. The ranging device 20 may be configured to emit a beam, receive a returned beam, and convert the returned beam into an electrical signal. The emitter 22 may be configured to emit a light pulse sequence. In some embodiments, the emitter 22 may emit a laser pulse sequence. In some embodiments, the laser beam emitted by the emitter 22 may include a narrow bandwidth beam with a wavelength outside of a visible light range. The collimation element 24 may be arranged on an emission path of the emitter 22 and further configured to collimate the beam emitted from the emitter 22 into parallel light to emit to the scan device. The collimation element 24 may be further configured to converge at least a part of the returned beam reflected by the detected object 200. The collimation element 24 may include a collimation lens or another element that can collimate the beam.

In some embodiments shown in FIG. 14, an emission optical path and a reception optical path of the LIDAR 100 may be combined through the optical path change element 28 before the collimation element 24. Thus, the emission optical path and the reception optical path may share the same collimation element 24 to cause the optical path to be more compact. In some other embodiments, each of the emitter 22 and the detector 26 may include a collimation element 24. The optical path change element 28 may be arranged at the optical path after the collimation element 24.

In some embodiments shown in FIG. 14, since a diameter of a beam hole of the emitter 22 for emitting the beam is relatively small, and a diameter of a beam hole of the LIDAR 100 for receiving the returned beam is relatively large, the optical path change element may use a reflection mirror with a small area to combine the emission optical path and the reception optical path. In some other embodiments, the optical path change element may also include a reflection mirror with a through-hole. The through-hole may be configured to transmit the emitted beam of the emitter 22. The reflection mirror may be configured to reflect the returned beam to the detector 26. As such, when a small reflection mirror is used, shielding of the returned beam by the holder of the small reflection mirror may be reduced.

In some embodiments shown in FIG. 14, the optical path change element 28 may be off the optical path of the collimation element 24. In some other embodiments, the optical path change element 28 may be located on the optical path of the collimation element 24.

The scan device 30 is arranged at the emission optical path of the ranging device 20. The scan device 30 may be configured to change a transmission direction of a collimated beam 50 emitted through the collimation element 24 and project to an external environment, and project the returned beam to the collimation element 24. The returned beam may be converged at the detector 26 through the collimation element 24.

In some embodiments, the scan device 30 may include at least one optical element 32, which may be configured to change the transmission direction of the beam. The optical element 32 may be configured to change the transmission direction of the beam by performing reflection, refraction, and diffraction on the beam. For example, the scan device 30 may include a lens, a reflection mirror, a prism, a galvanometer, a grating, a liquid crystal, an optical phased array, or any combination thereof. In some embodiments, at least a part of the optical elements 32 may be movable. For example, at least a part of the optical elements 32 may be driven to move by the driver 34. The movable optical elements 32 may reflect, refract, and diffract the beam to different directions at different times.

In some embodiments, a plurality of optical elements 32 of the scan device 30 may rotate or vibrate around a shared axis. Each rotating or vibrating optical element 32 may be configured to continuously change a transmission direction of an incident beam. In some embodiments, the plurality of optical elements 32 of the scan device 30 may rotate at different rotation speeds or vibrate at different speeds. In some other embodiments, at least the part of the optical elements 32 of the scan device 30 may rotate at a nearly same rotation speed.

In some other embodiments, the plurality of optical elements 32 of the scan device 30 may rotate around different rotation axes. In some other embodiments, the plurality of optical elements 32 of the scan device 30 may rotate in a same direction or in different directions, or vibrate in a same direction or different directions, which is not limited here.

In some embodiments, the scan device 30 includes a first optical element 322 and a first driver 342 connected to the first optical element 322. The first driver 342 may be configured to drive the first optical element 322 to rotate around the rotation axis 36 to cause the first optical element 322 to change the direction of the collimated beam 50. The first optical element 322 may project the collimated beam 50 in different directions. In some embodiments, an included angle between the direction of the collimated beam 50 after the first optical element 322 and the rotation axis 36 may change as the first optical element 322 rotates. In some embodiments, the first optical element 322 includes a pair of opposite surfaces that are not parallel. The collimated beam 50 may pass through the pair of surfaces. In some embodiments, the first optical element 322 may include at least a lens, whose thickness changes along a radial direction. In some embodiments, the first optical element 322 may include a wedge prism, which may be configured to refract the collimated beam 50.

In some embodiments, the scan device 30 further includes a second optical element 324. The second optical element 324 may rotate around the rotation axis 36. The second optical element 324 and the first optical element 322 may have different rotation speeds. The second optical element 324 may be configured to change the direction of the beam projected by the first optical element 322. In some embodiments, the second optical element 324 may be connected to a second driver 344. The second driver 344 may be configured to drive the second optical element 324 to rotate. The first optical element 322 and the second optical element 324 may be driven by the same driver or different drivers 34 to cause the rotation speeds and/or the rotation directions of the first optical element 322 and the second optical element 324 to be different. Thus, the collimated beam 50 may be projected to different directions of external space to scan a relatively large space area. In some embodiments, a controller 40 may be configured to control the first driver 342 and the second driver 344 to drive the first optical element 322 and the second optical element 324, respectively. The rotation speeds of the first optical element 322 and the second optical element 324 may be determined according to an expected scan area and style in practical applications. The first driver 342 and the second driver 344 may include motors or other drivers.

In some embodiments, the second optical element 324 may include a pair of opposite surfaces that are not parallel. The beam may pass through the pair of surfaces. In some embodiments, the second optical element 324 may include at least a lens whose thickness changes along a radial direction. In some embodiments, the second optical element 324 may include a wedge prism.

In some embodiments, the scan device 30 may include a third optical element 32 (not shown in the figure) and a third driver 34 (not shown) for driving the third optical element 32. In some embodiments, the third optical element 32 may include a pair of opposite surfaces that are not parallel. The beam may pass through the pair of surfaces. In some embodiments, the third optical element 32 may include at least a lens whose thickness changes along a radial direction. In some embodiments, the third optical element 32 may include a wedge prism. At least two of the first optical element 322, the second optical element 324, and the third optical element 32 may rotate at different rotation speeds and/or in different directions.

The optical elements 32 of the scan device 30 may rotate to project the collimated beam 50 to different directions, for example, directions 52 and 56. As such, the scan device 30 may scan the space around the LIDAR 100. When the projected beam of the scan device 30 encounters the detected object 200, a part of the beam may be reflected by the detected object 200 along an opposite direction 58 to the direction of the projected beam to the scan device 30. The returned beam reflected by the detected object 200 may be incident to the collimation element 24 after passing through the scan device 30 and received by the detector 26.

The detector 26 and the emitter 22 may be arranged on a same side of the collimation element 24. The detector 26 may be configured to convert at least the part of the returned beam that passes through the collimation element 24 into an electrical signal.

In some embodiments, the emitter 22 may include a laser device. The light pulse in the nano-second level may be emitted by the laser device. Further, the reception time of the light pulse may be determined. For example, the reception time of the light pulse may be determined by detecting at least one of the ascending edge time or the descending edge time of the electrical signal pulse. For example, the LIDAR 100 may calculate the TOF by using the pulse reception time information and the pulse transmission time information to determine the distance between the detected object 200 and the LIDAR 100.

Each of the first optical element 322, the second optical element 324, and the third optical element 32 may include the detection device 10 and the encoder disc 12. The encoder disc 12 may rotate as the optical elements 32 rotate to detect the rotation parameters of the optical elements 32, e.g., an absolute position of the optical element 32 (taking the zero position of the optical element 32 for reference). In some embodiments, each of the first optical element 322, the second optical element 324, and the third optical element 32 may include a wedged prism. The signal may be triggered when the optical elements 32 emit light and receive light to detect the absolute positions of the optical elements 32. As such, angles of the optical elements 32 may be obtained when the light is emitted, and the angles of the optical elements 32 may be obtained when the light returns to obtain the direction of the light emitted from the optical elements 32 and the direction of the light that returns to the optical elements 32. Thus, an orientation and a distance of the detected object 20 may be determined.

In some embodiments, the optical elements 32 may be coated with an anti-reflection film. In some embodiments, the thickness of the anti-reflection film may be equal to or close to a wavelength of the beam emitted by the emitter 22. The anti-reflection film may increase the intensity of the transmitted beam.

In some embodiments, a filter layer may be coated on a surface of an element of the LIDAR 100 in the transmission path of the beam, or a filter may be arranged in the transmission path of the beam, which may be configured to transmit the light with a wavelength within the wavelength band of the beam emitted by the emitter 22 and reflect the light of another wavelength band. Thus, the noise caused by environmental light may be reduced for the reception circuit.

The distance and orientation detected by the LIDAR 100 may be used for remote sensing, obstacle avoidance, surveying and mapping, modeling, navigation, etc. In some embodiments, the LIDAR 100 of embodiments of the present disclosure may be applied to a mobile platform. The LIDAR 100 may be mounted at a platform body of the mobile platform. The mobile platform having the LIDAR 100 may perform measurement on the external environment. For example, a distance between the mobile platform and an obstacle may be measured to avoid the obstacle, and 2-dimensional and 3-dimensional surveying and mapping may be performed on the external environment.

In some embodiments, the mobile platform may include at least one of an unmanned aerial vehicle (UAV), a vehicle (including a car), a remote vehicle, a ship, a robot, or a camera. When the LIDAR 100 is applied to the UAV, the platform body may be a vehicle body of the UAV. When the LIDAR 100 is applied to the car, the platform body may be a body of the car. The car may include an auto-pilot car or a semi-auto-pilot car, which is not limited here. When the LIDAR 100 is applied to the remote vehicle, the platform body may be the vehicle body of the remote vehicle. When the LIDAR 100 is applied to the robot, the platform body may be the robot. When the LIDAR 100 is applied to the camera, the platform body may be a camera body.

In the description of this specification, referring to the terms “certain embodiments,” “one embodiment,” “some embodiments,” “exemplary embodiments,” “examples,” “specific examples,” or “some examples,” the description means that specific features, structures, materials, or characteristics described in connection with embodiments or examples are included in at least one embodiment or example of the present disclosure. In this specification, the schematic description of the above terms does not necessarily refer to a same embodiment or example. The described specific features, structures, materials, or characteristics may be combined in any suitable manner in any one or more embodiments or examples.

Any process or method description described in the flowchart or described in other ways herein can be understood as a module, segment, or part of code that includes one or more executable instructions for performing specific logical functions or steps of a process. The scope of the preferred embodiments of the present disclosure includes additional executions, which may not be in the order shown or discussed, including executing functions in a substantially simultaneous manner or in the reverse order according to the functions involved, which should be understood by those skilled in the art to which embodiments of the present application belong.

The logic and/or steps represented in the flowchart or described in other ways herein, for example, can be considered as a sequenced list of executable instructions for executing logic functions, and can be executed in any computer-readable medium, for use by an instruction execution system, a device, or an apparatus (such as a computer-based system, a system including a processor, or another system that can fetch and execute instructions from the instruction execution system, device, or apparatus), or for use by combining the instruction execution system, the device, or the apparatus. For the present disclosure, the computer-readable medium may include any device that may include, store, communicate, transmit, transfer program for use by the instruction execution system, device, or apparatus or by combining the instruction execution system, device, or apparatus. Examples (non-exhaustive list) of the computer-readable medium may include an electrical connection device (electronic device) with one or more wiring, a portable computer disk case (magnetic device), random access memory (RAM), read-only memory (ROM), erasable and editable read-only memory (EPROM or Flash memory), a fiber optic device, and portable compact disk read-only memory (CDROM). In addition, the computer-readable medium may even include paper or another suitable medium on which the program can be printed. For example, optical scan may be performed on the paper or the another medium, and then editing, interpreting, or another suitable method when necessary may be performed to process to obtain the program in an electronic manner. Then, the program may be stored in the computer memory.

Each part of the present disclosure may be executed by hardware, software, firmware, or a combination thereof. In embodiments of the present disclosure, multiple steps or methods may be executed by software or firmware stored in a memory and executed by a suitable instruction execution system. For example, if the multiple steps or methods are performed by hardware, as in other embodiments, the multiple steps or methods may be performed by any one or a combination of the following technologies known in the art: a discrete logic circuit of a logic gate circuit for performing logic functions on data signals, an application-specific integrated circuit with a suitable combinational logic gate, a programmable gate array (PGA), a field-programmable gate array (FPGA), etc.

Those of ordinary skill in the art can understand that all or part of the steps that are carried for implementing the above-mentioned implementation method can be completed by a program instructing relevant hardware. The program can be stored in a computer-readable storage medium. When the program is executed, one of the steps of method embodiments or a combination thereof may be included.

In addition, functional units of embodiments of the present disclosure may be integrated into one processing module, or may exist alone physically, or two or more units may be integrated into one module. The above-mentioned integrated module can be executed in the form of hardware or a software function module. If the integrated module is executed in the form of a software function module and sold or used as an independent product, the integrated module may also be stored in a computer-readable storage medium.

The above-mentioned storage medium may include a read-only memory, a magnetic disk, an optical disk, etc. Although embodiments of the present disclosure have been shown and described above, above embodiments are exemplary and should not be considered as a limitation of the present disclosure. Those of ordinary skill in the art can make changes, modifications, substitutions, and variations to embodiments of the present disclosure within the scope of the present disclosure.

What is claimed is:

1. A detection method comprising:
obtaining first count data and second count data during rotation of an encoder disc mounted at and configured to rotate together with a rotation object; and
determining a rotation parameter of the rotation object according to the first count data and the second count data, the rotation parameter including a rotation angle and a rotation speed;
wherein:
the encoder disc includes N detection target portions arranged along a circumferential direction of the encoder disc, N being an integer greater than two;
the N detection target portions include N−K first detection target portions and K second detection target portions, K being an integer greater than or equal to 1 and smaller than N;
along the circumferential direction of the encoder disc, a width of one of the N−K first detection target portions is different from a width of one of the K second detection target portions;
the first count data is obtained when one detection target portion of the N detection target portions is detected; and
the second count data is recorded between two neighboring detection target portions of the N detection target portions.

2. The method of claim 1, wherein:
the first count data includes a count value; and
obtaining the first count data includes:
in response to detecting a zero position of the encoder disc, clearing the count value; and
in response to detecting the one detection target portion, obtaining the count value.

3. The method of claim 2, wherein the zero position of the encoder disc corresponds to a position of one of the K second detection target portions.

4. The method of claim 1, wherein:
the second count data includes a count value; and
obtaining the second count data includes:
in response to detecting one of the N−K first detection target portions or one of the K second detection target portions, clearing the count value; and
in response to receiving a trigger signal, obtaining the count value.

5. The method of claim 4, wherein the trigger signal includes a signal triggered when the rotation object emits light and/or receives light.

6. The method of claim 1, wherein:
the first count data includes a first count value and the second count data includes a second count value;
determining the rotation parameter of the rotation object according to the first count data and the second count data includes:
determining a rotation angle in a current rotation round of the encoder disc by using the first count value obtained in a last rotation round of the encoder disc and the second count value obtained in the current rotation round of the encoder disc; and
the rotation angle in the current rotation round of the encoder disc is a rotation angle in the current rotation round of the rotation object.

7. The method of claim 6, wherein:
determining the rotation angle in the current rotation round of the encoder disc by using the first count value obtained in the last rotation round of the encoder disc and the second count value obtained in the current rotation round of the encoder disc includes:
in response to receiving a trigger signal, determining the rotation angle in the current rotation round of the encoder disc by using the first count value obtained in the last rotation round of the encoder disc, the second count value obtained in the current rotation round of the encoder disc, and an accumulation value of the first count value obtained in the last rotation round of the encoder disc, of a last detection target portion in a rotation direction of the encoder disc;

8. The method of claim 1, wherein:
the first count data includes a first count value and a first count frequency;
the second count data includes a second count value and a second count frequency;
determining the rotation parameter of the rotation object according to the first count data and the second count data includes:
determining a rotation speed of the encoder disc according to the first count frequency and the first count value; and
the rotation speed of the encoder disc is the rotation speed of the rotation object.

9. The method of claim 8, wherein:
determining the rotation speed of the encoder disc according to the first count frequency and the first count value includes:
determining a time length needed for the encoder disc to rotate for a round according to the first count frequency and the first count value to determine the rotation speed of the encoder disc.

10. The method of claim 1, wherein:
along the circumferential direction of the encoder disc, the encoder disc is divided into N detection areas;
each of the N detection areas includes one of the detection target portions and an encoder disc portion; and
the detection target portions and the encoder disc portions are arranged alternately.

11. The method of claim 10, wherein:
the N encoder disc portions include N−K first encoder disc portions and K second encoder disc portions; and
along the circumferential direction of the encoder disc:
the width of the one of the first detection target portions is smaller than the width of the one of the second detection target portions; and
a width of one of the N−K first encoder disc portions is greater than a width of one of the K second encoder disc portions.

12. The method of claim 11, wherein, along the circumferential direction of the encoder disc:
the width of the one of the first detection target portions is equal to the width of the one of the second encoder disc portions;
the width of the one of the second detection target portions is equal to the width of the one of the first encoder disc portions; and
the width of the one of the second detection target portions is three times the width of the one of the first detection target portions.

13. The method of claim 1, wherein one of the detection target portions includes a through-hole, a magnetic member, a light transmission member, or a light reflection member.

14. A detection device comprising:
an encoder disc configured to be mounted at and rotate together with a rotation object, wherein:
the encoder disc includes N detection target portions arranged along a circumferential direction of the encoder disc, N being an integer greater than 2;
the N detection target portions include N−K first detection target portions and K second detection target portions, K being an integer greater than or equal to 1 and smaller than N;
along the circumferential direction of the encoder disc, a width of one of the N−K first detection target portions is different from a width of one of the K second detection target portions;
a detection member configured to detect the first detection target portions and the second detection target portions; and
a processor configured to in rotation of the encoder disc:
obtain first count data when one detection target portion of the N detection target portions is detected and second count data between two neighboring detection target portions of the N detection target portions; and
determine a rotation parameter of the rotation object according to the first count data and the second count data, the rotation parameter including a rotation angle and a rotation speed.

15. The device of claim 14, wherein:
the first count data includes a count value; and
the processor is further configured to:
in response to detecting a zero position of the encoder disc, clear the count value; and
in response to detecting the one detection target portion, obtain the count value.

16. The device of claim 14, wherein:
the second count data includes a count value; and
the processor is further configured to:
in response to detecting one of the N−K first detection target portions or one of the K second detection target portions, clearing the count value; and
in response to receiving a trigger signal, obtaining the count value.

17. The device of claim 14, wherein:
the first count data includes a first count value and a first count frequency;
the second count data includes a second count value and a second count frequency;
the processor is further configured to:
determine a rotation speed of the encoder disc according to the first count frequency and the first count value; and
the rotation speed of the encoder disc is the rotation speed of the rotation object.

18. The device of claim 14, wherein:
along the circumferential direction of the encoder disc, the encoder disc is divided into N detection areas;
each of the N detection areas includes one of the detection target portions and an encoder disc portion; and
the detection target portions and the encoder disc portions are arranged alternately.

19. A LIDAR comprising:
an optical element;
a driver for driving the optical element to rotate; and
a detection device configured to detect a rotation parameter of the optical element and including:
an encoder disc configured to be mounted at and rotate together with the optical element, wherein:
the encoder disc includes N detection target portions arranged along a circumferential direction of the encoder disc, N being an integer greater than 2;
the N detection target portions includes N−K first detection target portions and K second detection target portions, K being an integer greater than or equal to 1 and smaller than N;
along the circumferential direction of the encoder disc, a width of one of the N−K first detection target portions is different from a width of one of the K second detection target portions;
a detection member configured to detect the first detection target portions and the second detection target portions; and
a processor configured to in rotation of the encoder disc:
obtain first count data when one detection target portion of the N detection target portions is detected and second count data between two neighboring detection target portions of the N detection target portions; and
determine the rotation parameter of the optical element according to the first count data and the second count data, the rotation parameter including a rotation angle and a rotation speed.

20. The LIDAR of claim 19, wherein the optical element includes a prism or a lens.

21. The LIDAR of claim 20, wherein:
the prism has different thicknesses along a radial direction; and
the one of the K second detection target portions is aligned to a position where the prism has a minimal or maximal thickness.

22. The LIDAR of claim 19, wherein:
the optical element is arranged in a lens barrel;
the lens barrel includes a snap piece;
the encoder disc includes a snap slot; and
the snap piece is at least partially snapped in the snap slot to mount the encoder disc at the lens barrel.
